(19) United States
(12) Patent Application Publication
(10) Pub. No.: US 2021/0064051 A1
(43) Pub. Date: Mar. 4, 2021

(54) VEHICLE CARGO TRANSFER

(71) Applicant: Ford Global Technologies, LLC, Dearborn, MI (US)

(72) Inventors: Aed M. Dudar, Canton, MI (US); Kevin Lucka, Southfield, MI (US); Gregory Barilovich, Dearborn, MI (US)

(73) Assignee: Ford Global Technologies, LLC, Dearborn, MI (US)

(21) Appl. No.: 16/555,405

(22) Filed: Aug. 29, 2019

(51) Int. Cl. G05D 1/02; B60N 2/02; B60N 2/00

(52) U.S. Cl. CPC G05D 1/0225; B60N 2/0292; B60W 2040/0881; B60N 2/0232; B60K 2370/175; B60N 2/002

(57) ABSTRACT

A computer comprises a memory and a processor. The memory stores instructions executable by the processor to detect an occupant in a seat in a vehicle, the seat having a seat position in the vehicle, to receive a request for cargo loading of the vehicle at a specified loading location, to determine a vehicle orientation and path, including approaching the specified location oriented one of forward-facing and rear-facing, to stop the vehicle so that the seat position overlaps the loading location, and to operate the vehicle according to the orientation and path.

### BACKGROUND

Autonomous cars can offer conveniences for users as they may be able to engage in rest or leisure activities while a vehicle is being operated by its onboard computers and sensors. In one example, when an autonomous vehicle is operated for car sharing, an interior cabin of the vehicle may be partitioned either virtually or physically to provides separate spaces for different users.

### BRIEF DESCRIPTION OF THE DRAWINGS

FIG. 1 shows an exemplary vehicle interior.

FIG. 2 shows an exemplary vehicle.

FIG. 3 shows the vehicle of FIG. 1 approaching a loading location in a rear-facing direction.

FIGS. 4A-4B show a flowchart of an example process for operating the vehicle.

### DETAILED DESCRIPTION

### Introduction

Disclosed herein is a computer, comprising a memory and a processor. The memory stores instructions executable by the processor to detect an occupant in a seat in a vehicle, the seat having a seat position in the vehicle, to receive a request for cargo loading of the vehicle at a specified loading location, to determine a vehicle orientation and path, including approaching the specified loading location oriented one of forward-facing and rear-facing, to stop the vehicle so that the seat position overlaps the specified loading location, and to operate the vehicle according to the orientation and path.

The instructions may further include instructions to actuate the seat to rotate based on the vehicle orientation.

The instructions may further include instructions to detect a second occupant in a second seat in the vehicle, the second seat having a second seat position in the vehicle, based on the vehicle orientation, the specified loading location, and the second seat position, to determine a second vehicle orientation and a second path, including approaching the specified loading location oriented one of vehicle forward-facing and vehicle rear-facing, to stop the vehicle so that the second seat position overlaps the loading location, and to operate the vehicle according to the second orientation and second path.

The instructions may further include instructions to select one of the vehicle forward-facing direction or the vehicle rear-facing direction for navigating the vehicle further based on a road driving direction at an area including the loading location.

The instructions may further include instructions to identify a second seat position at an unoccupied seat of the vehicle based on the loading location, and then to output a message including a request for the occupant to move to the unoccupied seat.

The instructions may further include instructions to prior to picking up the occupant, select the seat in the vehicle for the occupant based on the loading location and an availability status of vehicle seat, and to output a message including the selected seat.

The instructions may further include instructions to detect the occupant based on data received from a vehicle sensor including at least one of an occupant weight sensor and an object detection sensor.

The occupant may be an object, the seat may be an object location in the vehicle, and the instructions may further include instructions to send an instruction to a robot to unload the object from the object location in the vehicle upon stopping the vehicle so that the seat position overlaps the loading location.

The loading location may be one of a location of a drive-through window, a window of a non-moving second vehicle, and a robotic cargo fulfilment center.

The instructions may further include instructions to determine the seat position overlaps the specified loading location upon determining that a reference point of the respective seat or a projection of the reference point on a ground surface is within the loading location.

Further disclosed herein is a method, comprising detecting an occupant in a seat in a vehicle, the seat having a seat position in the vehicle, receiving a request for cargo loading of the vehicle at a specified loading location, determining a vehicle orientation and path, including approaching the specified loading location oriented one of forward-facing and rear-facing, to stop the vehicle so that the seat position overlaps the specified loading location, and operating the vehicle according to the orientation and path.

The method may further include actuating the seat to rotate based on the vehicle orientation.

The method may further include detecting a second occupant in a second seat in the vehicle, the second seat having a second seat position in the vehicle, based on the vehicle orientation, the specified loading location, and the second seat position, determining a second vehicle orientation and a second path, including approaching the specified loading location oriented one of forward-facing and rear-facing, to stop the vehicle so that the second seat position overlaps the loading location, and operating the vehicle according to the second vehicle orientation and second path.

The method may further include selecting one of the vehicle forward-facing direction or the vehicle rear-facing direction for navigating the vehicle further based on a road driving direction at an area including the loading location.

The method may further include identifying a second position at an unoccupied seat of the vehicle based on the loading location, and then outputting a message including a request for the occupant to move to the unoccupied seat.

The method may further include, prior to picking up the occupant, selecting the seat in the vehicle for the occupant based on the loading location and an availability status of vehicle seat; and outputting a message including the selected seat.

The method may further include detecting the occupant based on data received from a vehicle sensor including at least one of an occupant weight sensor and an object detection sensor.

The method may further include sending an instruction to a robot to unload an object from an object location in the vehicle upon stopping the vehicle so that the seat position overlaps the specified loading location, wherein the occupant is the object and the seat is the object location in the vehicle.

The loading location may be one of a location of a drive-through window, a window of a non-moving second vehicle, and a robotic cargo fulfilment center.

The method may further include determining the seat position overlaps the specified loading location upon determining that a reference point of the respective seat or a projection of the reference point on a ground surface is within the loading location.

Further disclosed is a computing device programmed to execute any of the above method steps.

Yet further disclosed is a computer program product, comprising a computer readable medium storing instructions executable by a computer processor, to execute any of the above method steps.

### System Elements

An autonomous vehicle may be operated to navigate to loading locations to provide access for a vehicle occupant to load and/or unload cargo. An occupant can be limited or prevented from access to a loading location. In one example, a vehicle computer can be programmed to detect an occupant in a seat in a vehicle, the seat having a seat position in the vehicle. The computer can be further programmed to, upon receiving a request for cargo loading of the vehicle at a specified loading location, determine a vehicle orientation and path, to stop the vehicle so that the seat position overlaps the loading location, and to operate the vehicle according to the orientation and path.

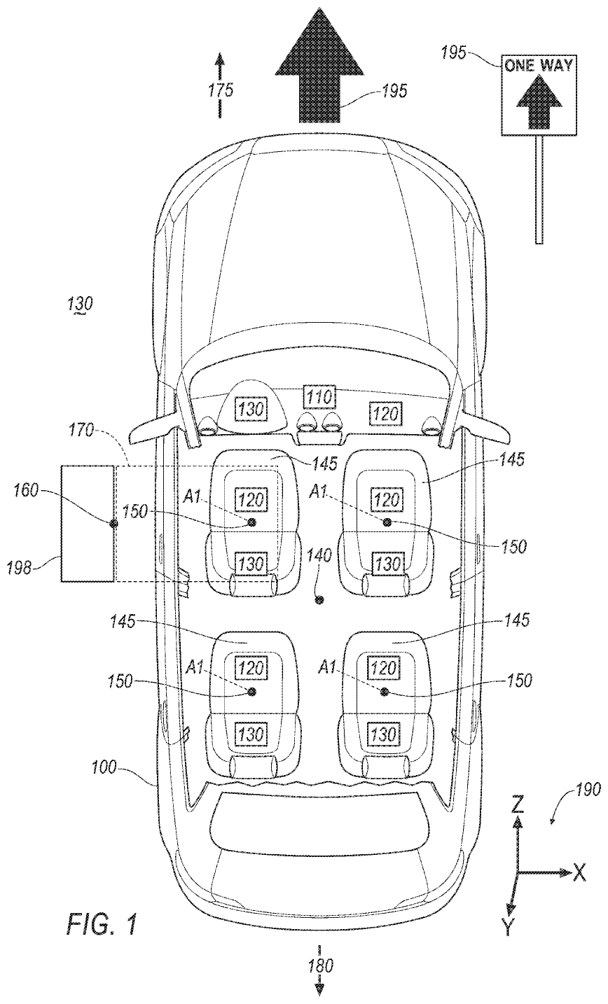

FIG. 1 illustrates an example vehicle 100 including a computer 110, actuator(s) 120, sensor(s) 130, and other components discussed hereinbelow. The vehicle 100 may be powered in a variety of known ways, e.g., including with an electric motor and/or internal combustion engine. The vehicle 100 may have a reference point 140. A reference point 140 may be a geometrical center point, e.g., a point at which respective longitudinal and lateral centerlines of the vehicle 100 intersect.

The computer 110 includes a processor and a memory such as are known. The memory includes one or more forms of computer-readable media, and stores instructions executable by the computer 110 for performing various operations, including as disclosed herein.

The computer 110 may operate the vehicle 100 in an autonomous or semi-autonomous mode. For purposes of this disclosure, an autonomous mode is defined as one in which each of vehicle 100 propulsion, braking, and steering are controlled by the computer 110; in a semi-autonomous mode the computer 110 controls one or two of vehicle 100 propulsion, braking, and steering; in a non-autonomous mode, a human operator controls vehicle propulsion, braking, and steering.

The computer 110 may include programming to operate one or more of vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations.

The computer 110 may include or be communicatively coupled to, e.g., via a vehicle communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network such as a bus in the vehicle such as a controller area network (CAN) or the like.

Via the vehicle network, the computer 110 may transmit messages to various devices in the vehicle and/or receive messages from the various devices, e.g., sensor(s) 130, actuator(s) 120, etc. Alternatively or additionally, in cases where the computer 110 actually comprises multiple devices, the vehicle communication network may be used for communications between devices represented as the computer 110 in this disclosure. Further, as mentioned below, various controllers and/or sensors may provide data to the computer 110 via the vehicle communication network.

The vehicle 100 actuators 120 may be implemented via circuits, chips, or other electronic components that can actuate various vehicle subsystems in accordance with appropriate control signals as is known. The actuators 120 may be used to control braking, acceleration, and steering of the first vehicle 100. As an example, the vehicle 100 computer 110 may output control instructions to control the actuators 120. The vehicle 100 may include one or more seat actuators 120 to rotate the seats 145 about an axis A1, as discussed below.

A 3D (three-dimensional) map of an area, in the context of the present disclosure, is a digital map including 3D location coordinates of points on surfaces, e.g., a road surface, buildings, etc., within the mapped area. For example, 3D location coordinates may be specified in a 3D Cartesian coordinate system 190. For example, location coordinates of a point on the road surface, a target point 160, etc., may be specified by X, Y, and Z coordinates. X and Y coordinates, i.e., horizontal coordinates, may be global positioning system (GPS) coordinates (i.e., lateral and longitudinal coordinates) or the like, whereas a Z coordinate may specify a vertical component to a location, i.e., a height (or elevation) of a point from a specified horizontal plane, e.g., a sea level.

The vehicle 100 may include one or more sensors 130, e.g., lidar (light detection and ranging) sensor(s) 130, camera sensors 130, etc., providing data encompassing at least some of an exterior of the vehicle 100. The computer 110 may be programmed to navigate the vehicle 100, e.g., through a drive-through, based on data received from the sensors 130 and 3D map data. For example, the target point 160 may be a reference point (e.g., a center point) of a window of a restaurant building 198. In another example, the target point 160 may be an installation location of a robot in a cargo fulfilment center 198.

A vehicle 100 orientation refers to a direction of travel, i.e., movement, of the vehicle 100, i.e., one of a forward direction 175 or a rear direction 180. Moving in the forward direction 175 means a vehicle 100 transmission is actuated to move in a forward gear. Moving in the rear direction 180 means the vehicle 100 transmission is actuated to move in a reverse gear. The computer 110 may be programmed to actuate a vehicle 100 actuator 120, e.g., propulsion actuator 120, transmission actuator 120, etc., to move the vehicle 100 in a forward (or forward-facing) direction 175 or a rear (or rear-facing or reverse) direction 180. Typically, a road lane, e.g., a drive-through, to approach a target point 160 is one-way. A specified direction of a road or lane is typically provided by a direction marker 195, e.g., an arrow painted on a road or other travel surface, an arrow on a traffic sign mounted on a side of the road, etc. Thus, the vehicle 100 is expected to move in the direction specified by the direction marker 195, as shown in FIG. 1, to approach the loading zone 170. Note that the vehicle 100 may move in a forward direction 175 or in a rear direction 180 as long as the vehicle 100 moves in the specified direction.

With reference to FIG. 1, the vehicle 100 may include multiple seats 145. A seat 145 may have a reference point 150, e.g., a point on a horizontal cross section typically approximating a geometric center of a square or rectangle shaped horizontal section. The seats 145 may be positioned in rows in an interior of the vehicle 100. For example, a seat 145 position may be identified as front right, front left, rear right, rear left. A position of a seat 145 may be identified by a location of the seat 145 reference point 150. Additionally or alternatively, the seats 145 may be positioned in any other suitable arrangement, e.g., in a circle. The seats 145 may be positioned adjacent one another, may be separated with physical partitioning, etc., thus dividing the interior of the vehicle 100 into multiple partitions, i.e., separated spaces, e.g., to provide privacy for individual vehicle 100 users.

The seat 145 may be rotatable about an axis A1 substantially perpendicular, e.g., at the reference point 150 of the respective seat 145, to a plane substantially parallel to a ground surface on which the vehicle 100 is situated. A seat actuator 120 may be mounted, e.g., under a seat 145, and may be configured to rotate the seat 145 to move from a forward direction 175 to a rear direction 180 or vice versa. A seat actuator 120 may include an electric motor and mechanical components mechanically coupled to the seat 145. The computer 110 may be programmed to actuate a seat actuator 120 to rotate the seat 145 around an axis A1 between a forward and a reverse position.

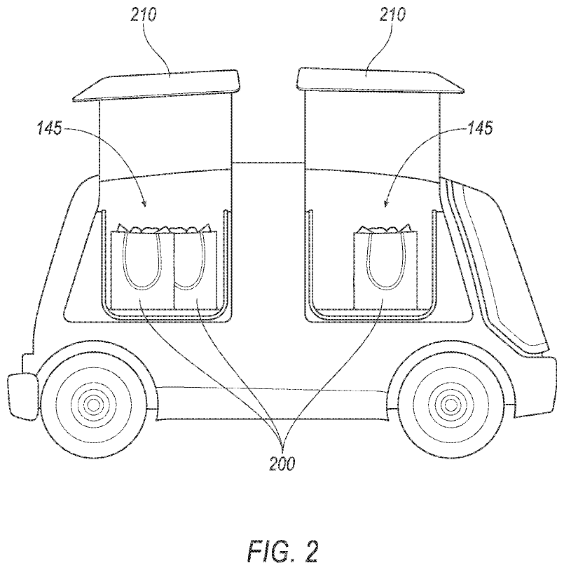

In another example, shown in FIG. 2, a seat 145 may include a platform, a container, etc., to place an object 200, e.g., a surface for placing a package. In this example, the vehicle 100 may be configured to transport cargo objects. An object 200 may be placed into the vehicle 100 on a seat 145 by opening a vehicle 100 door 210 and/or through a vehicle 100 window.

With reference to FIG. 1, a target point 160 is a point (typically specified as location coordinates) designated for loading and/or unloading cargo, e.g., 3D location coordinates of a drive-through window specified in the received 3D map data. The target point 160 is typically located adjacent (e.g., less than 30 centimeters away from) a drivable surface, e.g., road, parking area, etc. Additionally or alternatively, a target point 160 may be a second vehicle stopped in a parking area or on a side of a road, etc. An occupant of the vehicle 100 may receive or unload cargo, e.g., money, a payment card, a package, bagged goods, books, etc., through a vehicle 100 window, typically while seated in the vehicle 100. Thus, the vehicle 100 can be operated to locate the seat 145 of the occupant at a loading location 170 to facilitate loading and/or unloading of cargo. The computer 110 may be programmed to detect an occupant based on data received from a vehicle 100 sensor 130, e.g., an occupant weight sensor 130 mounted in and/or underneath the seat 145, an object detection sensor 130 such as a camera sensor 130, etc.

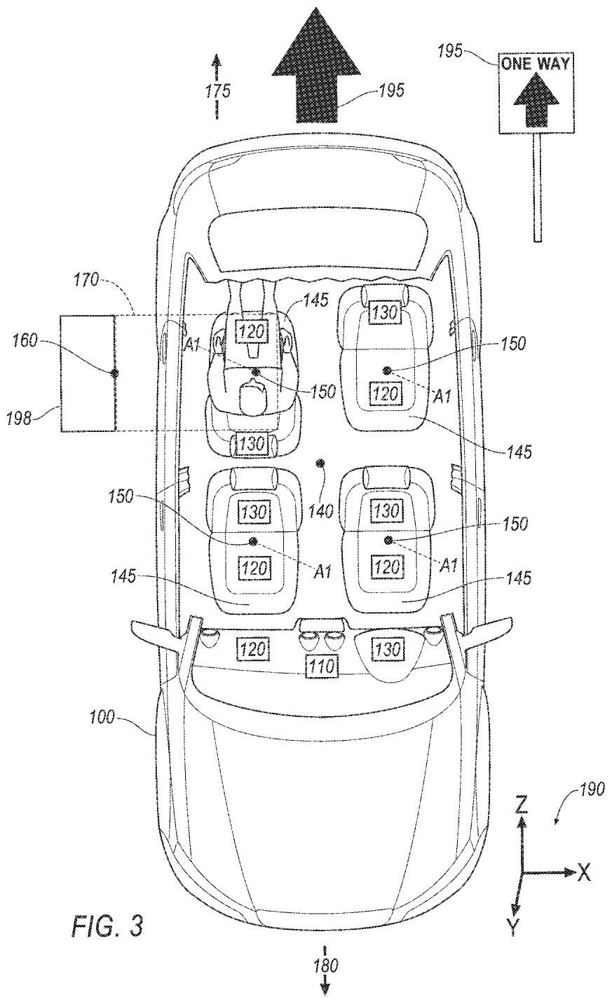

A loading location 170 is a two-dimensional area on a ground surface (or other travel surface such as a parking deck, elevated ramp, etc.). The loading location 170 is typically a rectangle or circle defined based on the location of the target point 160. For example, the loading location 170 may be a square-shaped area with each sides having a dimension of, e.g., 1 meter (m). The loading location 170 may be specified by (i) x, y coordinates of, e.g., a center point of a rectangle or circle, (ii) dimensions of the loading location 170 area, e.g., 1 m, and/or (iii) a relative position, i.e., right or left (with respect to a forward direction of travel on a travel surface past the target point 160) of the target point 160 relative to the loading location 170 in the specified direction of marker 195. For example, the relative position of the target point 160 shown in FIGS. 1 and 3 is “left,” i.e., at a left side of the loading location 170 in the specified direction of marker 195.

As discussed above with reference to FIG. 2, the seat 145 may be a surface, container, etc., for placing an object 200. Additionally or alternatively, the target point 160 may be robotic cargo fulfilment center. In one example, a computer may be programmed to actuate a robot at a target point 160 to place an object 200 in a vehicle 100 seat 145 and/or to remove the object 200 from the vehicle 100. In this context, the loading location 170 may be defined based on an access range of the robot, e.g., based on a length of a robot arm.

In the present context, a seat 145 overlaps a loading location 170 when the reference point 150 of the respective seat 145 or a projection of the reference point 150 on the ground surface is within the loading location 170. For example, as shown in FIG. 1, the reference point 150 of the front left seat 145 of the vehicle 100 is in the loading location 170. Thus, the front left seat 145 position overlaps the loading location 170. A projection of a reference point 150 on the ground surface may be a point having same x and y coordinates as the x and y coordinates of the reference point 150.

In one example, the computer 110 can be programmed to detect an occupant in a seat 145 in a vehicle, the seat 145 having a seat 145 position in the vehicle, to receive a request for cargo loading of the vehicle 100 at a specified loading location 170, to determine a vehicle 100 orientation and path, including approaching the specified location 170 oriented one of forward-facing direction 175 and rear-facing direction 180, to stop the vehicle so that the seat position overlaps the loading location 170, and to operate the vehicle 100 according to the orientation and path. A route is a series of waypoints to a destination. A path is a specified trajectory, e.g., in the form of a curved or straight line on the ground surface, that a vehicle 100 traverses to move from a first location to a second location, e.g., the target point 160. The computer 110 may be programmed to actuate the vehicle 100 actuator(s) 120 based on a specified path to cause a vehicle 100 movement on the path.

The computer 110 may be programmed to receive a request to load and/or unload cargo from a remote computer, user input provided via a human machine interface in the vehicle 100, etc. In the present context, a request to load and/or unload cargo loading may include: (i) loading location 170 data, i.e., location coordinates, dimensions of the loading location 170, and/or the relative position (i.e., left or right) of the target point 160 relative to the loading location 170, and (ii) a seat 145 position for loading, e.g., front left as shown in FIG. 1.

The computer 110 may be programmed to determine a route to the loading location 170 based on the map data and the location coordinates of the loading location. The computer 110 may be programmed to determine a path for the vehicle 100 such that the reference point 150 of the seat 145 identified in “request for cargo loading” is within the loading location 170 when the vehicle 100 stops.

With reference to example shown in FIG. 1, the computer 110 may be programmed to determine a path for the vehicle 100 moving in the forward direction 175 to stop each of the front left seat 145 or rear left seat 145 at the loading location 170. However, based on the direction of vehicle 100 movement specified by a marker 195, and the vehicle 100 moving in the forward-facing direction 175, the computer 110 may be unable to identify a path such that a front right seat 145 or a rear right seat 145 overlaps the loading location 170. In one example, the computer 110 may be programmed to identify an unoccupied seat 145 of the vehicle 100 based on the loading location 170, and then to output a message including a request for the occupant to move to the unoccupied seat 145. For example, with reference to FIG. 1, when an occupant is on the seat 145 at the front right position and the seat 145 at the front left position is unoccupied, the computer 110 may be programmed to output a message, e.g., to a display, including a request for the occupant to move to the seat 145 at the front left position.

In various examples, a movement of an occupant to another seat 145 overlapping the loading location 170 may be inconvenient or unpractical, e.g., when the seat 145 overlapping the loading location 170 is occupied by another occupant, a partitioning inside the vehicle 100 physically separates the seats 145 such that the occupant cannot move over, the occupant is disabled, etc.

With reference example shown in FIG. 3, the computer 110 may be programmed to select one of the vehicle forward direction or the vehicle reverse direction for navigating the vehicle 100 further based on a direction specified by a marker 195 at an area including the target point 160. As shown in FIG. 3, the computer 110 may be programmed to actuate the vehicle 100 actuator(s) 120 to move the vehicle 100 in the specified direction while the vehicle 100 moves in the rear-facing direction 180. Thus, the rear right seat 145 can overlap the loading location 170. The computer 110 may be programmed to determine a route including (i) moving the vehicle 100 in a forward-facing direction 175 until arrival to an area including the target point 160, e.g., a parking area of a drive-through restaurant, (ii) actuate the vehicle 100 actuator(s) 120 to move the vehicle 100 to the target point 160 in the rear-facing direction 180, (iii) navigating the vehicle 100 to a location, e.g., parking area, for changing the vehicle 100 orientation from rear-facing direction 180 to forward facing direction 175, (iv) actuating the actuator(s) 120 to move the vehicle 100 in the forward-facing direction 175 to a next destination.

A movement of a vehicle 100 in the rear-facing direction 180 may be inconvenient for an occupant facing the forward direction 175 of the vehicle 100 (i.e., occupant facing opposite the direction of vehicle 100 movement). In one example, upon selecting the rear-facing direction 180, the computer 110 may be programmed to actuate the seat 145 to rotate based on the vehicle 100 orientation, thus the occupant is then facing the specified direction, e.g., as specified by a marker 195.

In some examples, a request for cargo loading may include multiple seat 145 positions, e.g., the front right position and the front left position. In this example, the computer 110 may be programmed to actuate the vehicle 100 to navigate to the target points 160 multiple times in order to stop each occupant's seat 145 in the loading location 170. For example, vehicle 100 may approach the loading location 170 moving in the forward-facing direction 175 such that the front left seat 145 overlaps the loading location 170, then move to a location change a vehicle 100 orientation to move in the rear-facing direction 180 and approach the loading location 170 in the rear-facing direction 180 such that the front right seat 145 overlaps the loading location 170.

The computer 110 may be programmed, upon navigating the vehicle 100 such that the front left seat 145 with a first occupant overlaps the loading location 170 while the vehicle 100 moves in the front-facing direction, to detect a second occupant in a second seat, e.g., the front right seat 145, in the vehicle 100, the second seat 145 having a second seat 145 position in the vehicle 100. The computer 110 may be programmed, based on the vehicle 100 orientation, the specified loading location 170, and the second seat 145 position, to determine a second vehicle 100 orientation and a second path, including approaching the loading location 170 oriented one of forward-facing and rear-facing directions 175, 180, to stop the vehicle 100 so that the second seat 145 position overlaps the loading location 170, and to operate the vehicle 100 according to the second orientation and second path.

In some examples, a request for cargo loading may be received prior to pickup of an occupant. The computer 110 may be programmed, prior to picking up the occupant, to select a seat 145 in the vehicle 100 for the occupant based on the loading location 170 and an availability status of vehicle 100 seat 145, and to output a message including the selected seat 145. In an example vehicle 100 of FIG. 1, the computer 110 may be programmed to determine (i) upon determining that the target point 160 relative position is left (as defined above), then computer 110 selects a seat 145 with a left position such as the front left or rear left based on seat availability status (occupied or unoccupied), and (ii) upon determining that the target point 160 has a relative position of right, then the computer 110 selects a seat 145 with a right position such as the front right or rear right based on seat availability status. Thus, the vehicle 100 may approach the target point 160 in the forward-facing direction, if the occupant occupies the selected seat 145.

As discussed with reference to FIG. 3, the seat 145 may be an object 200 location such as a surface, container, etc., for transporting an object 200, e.g., a cargo item. The computer 110 may be programmed to send an instruction to a robot to unload the object 200 from the object location, e.g., front left position, in the vehicle 100 upon stopping the vehicle 100 so that the seat 145 position overlaps the loading location 170. Additionally or alternatively, the computer 110 may be programmed to send an instruction to the robot to place an object 200 in the vehicle 100, e.g., at the front left position. Additionally or alternatively, the computer 110 may be programmed to actuate a vehicle 100 door 210 opener to open the door 210 for placing or removing of the object 200, and to close the door 210 upon completion of placing or removal of the object 200.

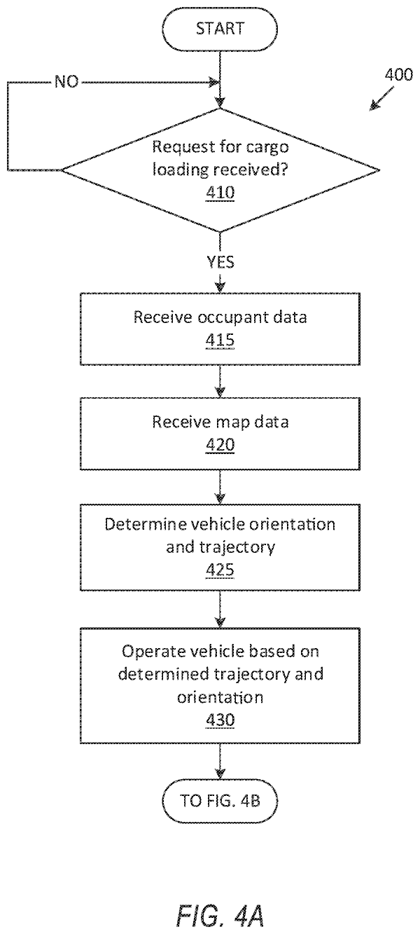

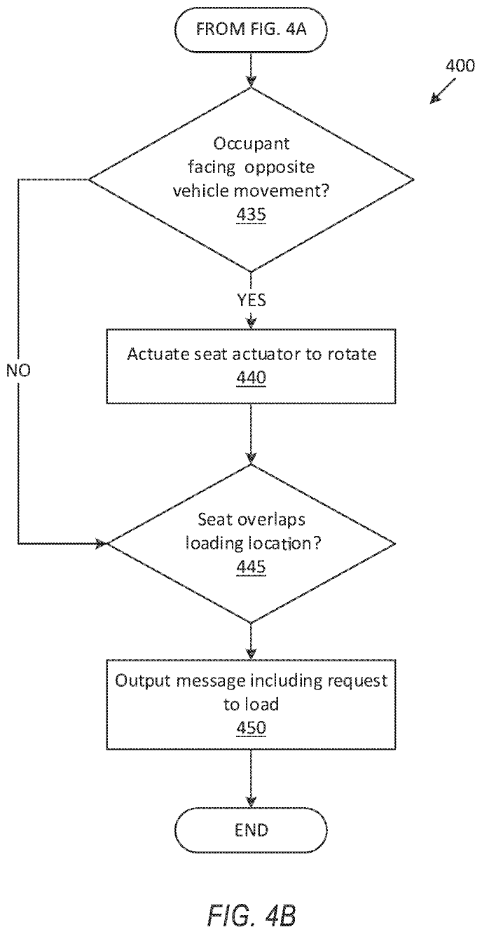

FIGS. 4A-4B are a flowchart for an example process 400 for operating the vehicle 100. A vehicle 100 computer 110 may be programmed to execute blocks of the process 400.

With reference to FIG. 4A, the process 400 begins in a decision block 410, in which the computer 110 determines whether a request for loading is received. The computer 110 may receive a request for loading from a remote computer, a device in the vehicle 100, a human machine interface of the vehicle 100, etc. If the computer 110 determines that a request for cargo loading is received, then the process 400 proceeds to a block 415; otherwise the process 400 returns to the decision block 410.

In the decision block 410, the computer 110 receives occupant data. The computer 110 may be programmed to receive vehicle 100 sensor 130 data, e.g., data from vehicle 100 weight sensor(s) 130, interior camera sensor 130, etc., and to detect occupant(s) in the vehicle 100. The computer 110 may be programmed to determine a seat 145 position of the detected occupant(s).

Next, in a block 420, the computer 110 receives map data. The computer 110 may be programmed to receive 3D map data such as point cloud data.

Next, in a block 425, the computer 110 determines a vehicle 100 orientation and path for navigating to the loading location 170. The computer 110 may be programmed to determine a route to the target point 160, and an orientation and path for the vehicle 100 to approach the loading location 170. As discussed with reference to FIG. 3, the computer 110 may be programmed to determine a path to a location, e.g., a parking area, to change a vehicle 100 orientation and approach the loading location 170 in a rear-facing direction 180.

Next, in a block 430, the computer 110 operates the vehicle 100 based on the determined vehicle 100 path and orientation, i.e., in one for a forward direction 175 and a backward direction 180, to the loading location 170. The computer 110 may be programmed to actuate the vehicle 100 propulsion, braking, and/or steering actuators 120 to navigate the vehicle 100 to the loading location 170.

With reference to FIG. 4B, in a decision block 435, the computer 110 determines whether the occupant(s) face an opposite direction of vehicle 100 movement, e.g., facing forward while the vehicle 100 is moving in the rear-facing direction 180. If the computer 110 determines that the occupant(s) is/are facing the opposite direction of the vehicle 100 movement, then the process 400 proceeds to a block 440; otherwise the process 400 proceeds to a decision block 445.

In the block 440, the computer 110 actuates a seat 145 actuator 120 to rotate the seat 145 to the direction of vehicle 100 movement. For example, when the vehicle 100 moves in a rear-facing direction 180, the computer 110 may actuate the seat 145 actuator 120 to rotate to the rear-facing direction 180. In one example, the computer 110 may be programmed to actuate a seat 145 actuator 120 to rotate upon determining based on the vehicle 100 sensor 130 data that the seat 145 is occupied.

Next, in a decision block 445, the computer 110 determines whether the seat 145 overlaps with the loading location 170. The computer 110 determines whether the reference point 150 (or a projection of the reference point 150 on the ground surface) of the seat 145 included in the request for cargo loading, e.g., the seat 145 at the front left position, is within the loading location 170. If the computer 110 determines that the seat 145 overlaps the loading location 170, then the process 400 proceeds to a block 450; otherwise the process 400 ends, or alternatively returns to the block 410, although not shown in FIGS. 4A-4B.

In the block 450, the computer 110 outputs a message including a request to load and/or unload cargo. The computer 110 may be programmed to output a message to a vehicle 100 display including a request to load, e.g., receive or drop off a package at the target point 160. Additionally or alternatively, the computer 110 may be programmed to output a message to a remote computer, e.g., a computer controlling a robot at the target point 160, to load an object 200 in the vehicle 100 and/or unload an object 200 from the vehicle 100. Additionally or alternatively, the computer 110 may be programmed to actuate a vehicle 100 door or window actuator 120 to open to allow receiving or drop off a package or object 200.

Following the block 450, the process 400 ends, or alternatively returns to the block 410, although not shown in FIGS. 4A-4B.

Computing devices as discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computing device is generally a collection of data stored on a computer readable medium, such as a storage medium, a random-access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random-access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A computer, comprising a memory and a processor; the memory storing instructions executable by the processor to:
detect an occupant in a seat in a vehicle, the seat having a seat position in the vehicle;
receive a request for cargo loading of the vehicle at a specified loading location;
determine a vehicle orientation and path, including approaching the specified loading location oriented one of forward-facing and rear-facing, to stop the vehicle so that the seat position overlaps the specified loading location; and
operate the vehicle according to the orientation and path.

2. The computer of claim 1, wherein the instructions further include instructions to actuate the seat to rotate based on the vehicle orientation.

3. The computer of claim 2, wherein the instructions further include instructions to:
detect a second occupant in a second seat in the vehicle, the second seat having a second seat position in the vehicle;
based on the vehicle orientation, the specified loading location, and the second seat position, determine a second vehicle orientation and a second path, including approaching the specified loading location oriented one of vehicle forward-facing and vehicle rear-facing, to stop the vehicle so that the second seat position overlaps the loading location; and
operate the vehicle according to the second orientation and second path.

4. The computer of claim 2, wherein the instructions further include instructions to select one of the vehicle forward-facing direction or the vehicle rear-facing direction for navigating the vehicle further based on a road driving direction at an area including the loading location.

5. The computer of claim 1, wherein the instructions further include instructions to:
identify a second seat position at an unoccupied seat of the vehicle based on the loading location; and
then output a message including a request for the occupant to move to the unoccupied seat.

6. The computer of claim 1, wherein the instructions further include instructions to:
prior to picking up the occupant, select the seat in the vehicle for the occupant based on the loading location and an availability status of vehicle seat; and
output a message including the selected seat.

7. The computer of claim 1, wherein the instructions further include instructions to detect the occupant based on data received from a vehicle sensor including at least one of an occupant weight sensor and an object detection sensor.

8. The computer of claim 1, wherein:
the occupant is an object;
the seat is an object location in the vehicle; and
the instructions further include instructions to send an instruction to a robot to unload the object from the object location in the vehicle upon stopping the vehicle so that the seat position overlaps the loading location.

9. The computer of claim 1, wherein the loading location is one of a location of a drive-through window, a window of a non-moving second vehicle, and a robotic cargo fulfilment center.

10. The computer of claim 1, wherein the instructions further include instructions to determine the seat position overlaps the specified loading location upon determining that a reference point of the respective seat or a projection of the reference point on a ground surface is within the loading location.

11. A method, comprising:
detecting an occupant in a seat in a vehicle, the seat having a seat position in the vehicle;
receiving a request for cargo loading of the vehicle at a specified loading location;
determining a vehicle orientation and path, including approaching the specified loading location oriented one of forward-facing and rear-facing, to stop the vehicle so that the seat position overlaps the specified loading location; and
operating the vehicle according to the orientation and path.

12. The method of claim 11, further comprising actuating the seat to rotate based on the vehicle orientation.

13. The method of claim 12, further comprising:
detecting a second occupant in a second seat in the vehicle, the second seat having a second seat position in the vehicle;
based on the vehicle orientation, the specified loading location, and the second seat position, determining a second vehicle orientation and a second path, including approaching the specified loading location oriented one of forward-facing and rear-facing, to stop the vehicle so that the second seat position overlaps the loading location; and
operating the vehicle according to the second vehicle orientation and second path.

14. The method of claim 12, further comprising selecting one of the vehicle forward-facing direction or the vehicle rear-facing direction for navigating the vehicle further based on a road driving direction at an area including the loading location.

15. The method of claim 11, further comprising:
identifying a second position at an unoccupied seat of the vehicle based on the loading location; and
then outputting a message including a request for the occupant to move to the unoccupied seat.

16. The method of claim 11, further comprising:
prior to picking up the occupant, selecting the seat in the vehicle for the occupant based on the loading location and an availability status of vehicle seat; and
outputting a message including the selected seat.

17. The method of claim 11, further comprising detecting the occupant based on data received from a vehicle sensor including at least one of an occupant weight sensor and an object detection sensor.

18. The method of claim 11, further comprising sending an instruction to a robot to unload an object from an object location in the vehicle upon stopping the vehicle so that the seat position overlaps the specified loading location, wherein the occupant is the object and the seat is the object location in the vehicle.

19. The method of claim 11, wherein the loading location is one of a location of a drive-through window, a window of a non-moving second vehicle, and a robotic cargo fulfilment center.

20. The method of claim 11, further comprising determining the seat position overlaps the specified loading location upon determining that a reference point of the respective seat or a projection of the reference point on a ground surface is within the loading location.
